(19) United States
(12) Patent Application Publication
(10) Pub. No.: US 2004/0073599 A1
(43) Pub. Date: Apr. 15, 2004

(54) Information acquisition control unit, information acquisition control system, Information acquisition control method, Information acquisition control program, recording medium with the program recorded therein, and navigation system

(75) Inventor: Takeharu Arakawa, Kawagoe-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 10/670,386

(22) Filed: Sep. 26, 2003

(30) Foreign Application Priority Data
Sep. 27, 2002 (JP) 2002-283553

(51) Int. Cl. G06F 15/16

(52) U.S. Cl. 709/200

(57) ABSTRACT

When information is acquired, also information concerning the current date and time is required. Time information concerning the term of validity or the like included in the information previously acquired is read by the communication possibility determining section (485). If the current data is not over the term of validity, it is determined that the communicating operation can not be executed. When the term of validity has expired, it is determined that the communicating operation can be executed. When it is determined that the communicating operation can be executed, the set processing section (483) controls the terminal communication section (410) to execute the processing for acquiring information from the main server device (300) or the like. With the configuration, increase of processing load and communication cost due to execution of unnecessary communicating operations can be prevented, and efficient information acquisition can be performed.

### BACKGROUND OF THE INVENTION

1. Field of the Invention

The present invention relates to an information acquisition control unit for controlling acquisition of information according to the necessity, an information acquisition control system, an information acquisition control method, an information acquisition control program, a recording medium with the program recorded therein, and a navigation system.

2. DESCRIPTION OF RELATED ART

There has been known a navigation system for guiding a movable body such as a vehicle, an airplane, and a vessel by providing guidance for movement of the movable body. The well-known navigation system based on the conventional technology detects the current position of a movable body and sets a route from the detected current position to the destination specified by a user based on map information recorded in a recording medium such as an optical disk. Then the navigation system superimposes the travel route on the map information to assist the user in driving the movable body.

On the other hand, in association with the recent progress in the field of communication technology, it is now possible to relatively quickly acquire a relatively large volume of information. Because of this feature, various configurations of the navigation system having communication function are now conceivable including those in which a mobile communication terminal such as a mobile telephone or a PHS (Personal Handyphone System) is used, or in which a communicating section capable of sending and receiving information via a radio communication medium is provided for enabling communications. For instance, it is conceivable to acquire, by means of communication, map information, information concerning weather at the destination, or information concerning various types of shops along the travel route for improving convenience during movement of the movable body.

In the navigation system based on the communication system, however, if it is tried to frequently acquire information by keeping the communication system online to acquire information through continuous communication, updated information can always be acquired, but the load to the communication system for continuously acquiring information becomes larger, and therefore sometimes other operations for processing information may disadvantageously be delayed, or a complicated and expensive configuration capable of responding to the large processing load may be required, which is also disadvantageous. In addition, also such disadvantages as increase in communication cost may occur due to the continuous connection of the communication line.

### SUMMARY OF THE INVENTION

A main object of the present invention is to provide an information acquisition control unit, an information acquisition control system, an information acquisition control method, an information acquisition control program, a recording medium with the program recorded therein, and a navigation system each enabling to easily acquire necessary information according to the necessity.

The information acquisition control unit according to the present invention is characterized in that the information acquisition control unit comprises an information acquiring section for acquiring information; an information processing section for associating the information acquired by the information acquiring section with acquisition condition information concerning the conditions for making the information acquiring section execute an information acquiring operation to acquire information; an acquisition possibility determining section for determining, based on the acquisition condition information, whether or not the acquiring operation can be executed; and a control section for controlling the information acquiring section, when it is determined by the acquisition possibility determining section that the acquiring operation can be executed, to execute the acquiring operation.

The information acquisition control unit according to the present invention is characterized in that the information acquisition control unit comprises an information acquiring section for acquiring information including acquisition condition information concerning the conditions for executing an acquiring operation to acquire information; an acquisition possibility determining section for determining, based on the acquisition condition information of the acquired information, whether or not the acquiring operation can be executed; and a control section for controlling the information acquiring section, when it is determined by the acquisition possibility determining section that the acquiring operation can be executed, to execute the acquiring operation.

The information acquisition control unit according to the present invention is characterized in that the information acquisition control unit comprises an information acquiring section for acquiring information; an input section for setting and inputting an acquisition demand information concerning a demand for an acquiring operation to acquire the information by the information acquisition section in response to an input operation; an acquisition possibility determining section for determining whether or not the information demanded from the acquisition demand information and the information acquired by the information acquiring section are identical to each other, and for determining, when the two pieces of information are not identical to each other, that the acquiring operation can be executed; and a control section for controlling the information acquiring section, when it is determined by the acquisition possibility determining section that the acquiring operation can be executed, to execute the acquiring operation.

The information acquisition control system according to the present invention is characterized in that the information acquisition control system comprises an information storing section for distributably storing therein different types of updatable information; and the information acquisition control unit according to the present invention connected thereto so that the information stored in this information storing section can be acquired by said information acquiring section.

The information acquisition control method according to the present invention is an information acquisition control method for controlling information acquisition with a computing section, and is characterized in that the computing section associates the acquired information with an acquisition condition information concerning the conditions for executing an acquiring operation to acquire information, determines, based on the acquisition condition information associated with the information, whether or not the acquiring operation can be executed, and executes the acquiring operation to separately acquire the information when it is determined that the acquiring operation can be executed.

The information acquisition control method according to the present invention is for controlling information acquisition with a computing section, and is characterized in that the method comprises the steps of determining, based on the acquisition condition information in the information acquired in advance and including acquisition condition information concerning the conditions for executing an acquiring operation to acquire the information; and executing the acquiring operation to separately acquire the information when it is determined that this acquiring operation can be executed.

The information acquisition control method according to the present invention is for controlling information acquisition with a computing section, and is characterized in that the method comprises the steps of recognizing an input for setting an acquisition demand information concerning a demand for an acquiring operation to acquire information in response to the input operation; and executing the acquiring operation to separately acquire information when it is determined by means of comparison that the information demanded from the acquisition demand information and the acquired information are not identical to each other.

The information acquisition control program according to the present invention is characterized in that the program makes the computing section execute the information acquisition control method according to the present invention.

The recording medium according to the present invention is characterized in that the recording medium records therein the information acquisition control program according to the present invention so that it can be read by the computing section.

The navigation system according to the present invention is characterized in that the system comprises an information acquisition control system for storing therein information concerning movement of a movable body as information; a movable body information acquiring section provided in the information acquisition control unit of this information acquisition system for acquiring information concerning the state of movement of a movable body; and a guidance reporting section provided in the information acquisition control unit for reporting at least either one of the acquired information and a guidance corresponding to the state of movement of a movable body based on this acquired information.

### BRIEF DESCRIPTION OF THE DRAWINGS

FIG. 1 is a block diagram showing general configuration of a navigation system according to one embodiment of the present invention;

FIG. 2 is a flow chart showing operation steps in the embodiment for determining whether an operation for acquiring information can be executed or not;

FIG. 3 is a flow chart showing operation steps in the embodiment for determining whether an operation for acquiring information can be executed or not; and

FIG. 4 is a flow chart showing operation steps in another embodiment of the present invention for determining whether an operation for acquiring information can be executed or not.

### DETAILED DESCRIPTION OF PREFERRED EMBODIMENT(S)

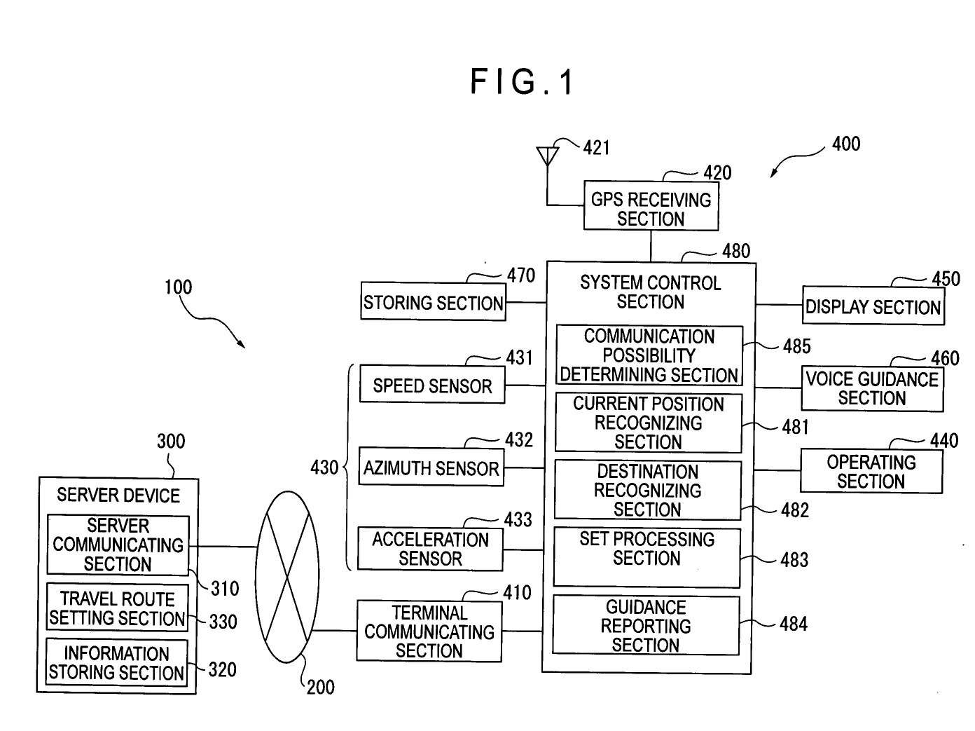

An embodiment of the present invention is described below with reference to the related drawings. In this embodiment, a navigation system is described as an example of the information acquisition control system according to the present invention. FIG. 1 is a block diagram showing the navigation system.

(Configuration of the Navigation System)

In FIG. 1, the reference numeral 100 indicates a navigation system, and this navigation system guides a movable body such as a vehicle, an airplane, or a vessel in response to movement of the movable body. The navigation system 100 comprises a network 200, a main server 300, and a terminal device 400 as a guiding device.

Connected to the network 200 are the terminal device 400, main server 300, and other various types of server devices not shown in the figure. Further the terminal device 400, main server 300, and other various types of server devices are connected to the network 200 so that transaction of information can be executed therebetween. As the network 200, there can be enlisted, for instance, the Internet based on a general purpose protocol such as TCP/IP, Intranet, LAN (Local Area Network), a communication line network or a broadcasting network with a plurality of earth stations forming a network enabling information transaction through a radio media, and further a radio media itself as a medium for direct information transaction among the terminal device 400, main server 300, and various types of server devices. The radio media may be based on any of electric waves, light, sonic waves, electromagnetic waves, or the like.

The various types of server devices (not shown) are installed in various institutions such as various public offices like meteorological office, metropolitan police office private organizations, Vehicle Information and Communication System (VICS), and business organizations so that various types of information can be distributed therefrom. The information distributed therefrom is the information which might be useful for the drivers of vehicles during the movement such as, for instance, weather information, traffic information concerning traffic jamming, traffic accidents, construction works, traffic controls or the like, store information concerning various types of stores such as gasoline stations or restaurants.

The main server 300 can send and receive information to and from the terminal device 400 and various types of server devices via the network 200. The main server 300 comprises a server communication section 310, an information storing section 320, and a travel route setting section 330.

The server communication section 310 is connected to the network 200. The server communication section 310 receives information from the terminal device 400 and various types of server devices via the network 200, and also sends information to the terminal device 400 and various types of server devices via the network 200.

The information storing section 320 stores therein map information or various types of information received from the terminal device 400 or the various types of server devices so that the information can be read out therefrom. The information stored therein can be updated according to the necessity by an input device (not shown) and provided, for instance, in the main server 300.

The travel route setting section 330 sets a travel route from a current position of a movable body such as a vehicle, on which the terminal device 400 is mounted, up to the destination and generates the travel route information based on the information acquired via the network 200 from the terminal device 400, specifically the current position information described hereinafter, information concerning the destination and information concerning the matters to be referenced for setting the route, and depending on the map information stored in the information storing section 320. More specifically, the travel route setting section 330 searches for routes possible to run based on the map information, selects routes through which the vehicle can arrive at the destination within a shorter period of time, routes each with a shorter distance, or those evading places where traffic jamming often occurs or the traffic control is strict, and generates the travel route.

The terminal device 400 is mounted, for instance, on a movable body such as a vehicle, and runs on the electric power supplied by a battery or other electric power supply unit such as a battery cell provided separately. The terminal device 400 comprises a terminal communication section 410 as an information acquiring section, a GPS (Global Positioning System) receiving section 420, a detecting section 430, and operating section 440 as an input section, a display section 450, a voice guidance section 460, a storing section 470, and a system control section 480 as a computing section.

The terminal communication section 410 has, for instance, a communication antenna (not shown), and is connected to earth stations (not shown), which constitute the network 200, via a radio media so that information can be sent and received thereby. This terminal communication section 410 is connected to the system control section 480. The terminal communication section 410 transmits the information acquired from the system control section 480 to the main server 300 or other various types of institutions (not shown) via the network 200 under controls by the system control section 480, receives the information sent from the main server 300 or various types of server devices, and outputs the information to the system control section 480. It should be noted that any configuration, such as the configuration without communication antennas, is allowable for the connection to the network 200 as long as information transaction can be performed.

A GPS antenna 421 is connected to the GPS receiving section 420. This GPS receiving section 420 receives navigation electric waves emitted from a GPS satellite, which is an artificial satellite (not shown), via the GPS antenna 421. The GPS receiving section 420 computes simulated coordinate values for the current position based on a received signal, and outputs the simulated coordinate values as GPS data to the system control section 480.

The detecting section 430 detects a moving state of the vehicle. The detecting section 430 comprises a speed sensor 431, an azimuth angle sensor 432, an acceleration sensor 433, and the like.

The speed sensor 431 is mounted on a vehicle, and detects running velocity and actual acceleration of the vehicle based on a signal varying in response to the velocity of the vehicle. This speed sensor 431 reads a pulse signal or a voltage value outputted in association with rotation of, for instance, the shaft or the wheel. The speed sensor 431 outputs detection information such as the pulse signal or voltage value read as described above to the system control section 480.

The azimuth angle sensor 432 is mounted on a vehicle, has a so-called gyro sensor (not shown), and detects the azimuth angle of the vehicle, namely a direction in which the vehicle moves. This azimuth sensor 432 outputs a signal for detected information concerning the detected running direction to the system control section 480.

The acceleration sensor 433 is mounted on a vehicle, and detects the acceleration in the vehicle's running direction. The acceleration sensor 433 converts the detected acceleration to a sensor output value for the detected information such as, for instance, a pulse or a voltage, and outputs the sensor output value to the system control section 480.

The operating section 440 has various types of operation buttons (not shown) used for input operations. The operation buttons are used for inputting, for instance, an instruction for execution of a communicating operation, which is communication demand information as information acquisition information for acquiring information, through the network 200, or for setting contents of the information to be acquired or conditions for acquiring the information, a destination, a contents of operations of the terminal device 400 for, for instance, displaying the running state of the vehicle, or the like. The operating section 440 outputs any of prespecified signals according to the necessity to the system control section 480 in response to an input operation with the operation buttons for setting the specified matters. It should be noted that this operating section 440 is not limited to the configuration based on the operation buttons, and for instance, a touch panel provided on the display section 450 or even voice may be used for inputting various conditions for information acquisition.

The display section 450 is controlled by the system control section 480 and displays the image data from the system control section 480 on a screen. The image data includes, in addition to the image data such as map information or other additional information sent from the main server 300 or other various server devices, TV image data received by a TV receiver (not shown), and image data recorded in a recording medium such as an optical disk or a magnetic disk and read with a drive. As the display section 450, for instance, a liquid-crystal or organic EL (electroluminescence) panel, a PDP (Plasma Display Panel), or a CRT (Cathode-Ray Tube) may be used.

The voice guidance section 460 has a voice-generating section such as a speaker (not shown). This voice guidance section 460 reports various types of information such as those on the vehicle's running direction or running state or other necessary information for driving a vehicle to a driver or other persons in the vehicle with voice generated from the voice-generating section. The voice-generating section can output the TV voice and sound data received with the TV receiver or other voice data recorded in an optical disk or a magnetic disk. The voice guidance section 460 is not limited to the configuration based on the voice-generating section, and other voice-generating unit mounted on a vehicle may be used for this purpose.

The storing section 470 has a drive or a driver for readably storing or recording information on a recording medium (not shown) such as, for instance, an optical disk, a magnetic disk, or a memory. The storing section 470 stores therein the information acquired through the network 200, matters set in response to an input operation in the operating section 440, or music or image data.

The system control section 480 comprises various types of input/output ports (not shown) such as, for instance, a communication port to which the terminal communication section 410 is connected, a GPS receiving port to which the GPS receiving section 420 is connected, sensor ports to which the sensors 431, 432, and 433 are connected respectively, a key input port to which the operating section 440 is connected, a display section control port to which the display section 450 is connected, a voice control port to which the voice guidance section 460 is connected, and a memory port to which the storing section 470 is connected. Further the system control section 480 has an incorporated memory (not shown). This incorporated memory stores therein, for instance, various types of programs developed on the OS (Operating System), which controls operations of the entire terminal device 400.

The system control section 480 comprises various types of programs such as: a current position recognizing section 481, a destination recognizing section 482, a set processing section 483 as a control section also functioning as an information processing section, a guidance reporting section 484, and a communication possibility determining section 485 as an information acquisition possibility determining section. The system control section 480 has an incorporated clock (not shown) and can acquire time information concerning a current data and time.

The current position recognizing section 481 recognizes a current position of a vehicle. More specifically, the current position recognizing section 481 computes a plurality of simulated positions for a current position of the vehicle based on the speed data as well as azimuth angle data of the vehicle outputted from the speed sensor 431 and the azimuth sensor 432. Further the current position recognizing section 481 recognizes simulated coordinate values for the vehicle's current positions based on the GPS data concerning the current position outputted from the GPS receiving section 420. The current position recognizing section 481 recognizes the current position by comparing the simulated positions computed as described above to the simulated coordinate values for the current position recognized as described above and computing the current position of the vehicle on the map information separated acquired.

The current position recognizing section 481 determines an inclination or a difference in height of a road on which the vehicle is running based on the acceleration data outputted from the acceleration sensor 433 to compute a simulated current position of the vehicle and recognize the current position. Namely, with the current position recognizing section 481, it is possible to accurately recognize a current position of a vehicle at a cubic interchange or on a highway, namely at any place including a point on a multilayered road facilities on a plain. Further, when running on a mountain path or a sloped road, it is possible to precisely recognize a current position of a vehicle by correcting the error between a travel distance obtained only from the speed data and azimuth data and the actual travel distance of the vehicle applying the detected inclination of the road.

The current position recognizing section 481 can recognize, in addition to a current position of a vehicle as described above, the other point such as the start point set and inputted in the operating section 440 as a simulated current position. The various types of information obtained by the current position recognizing section 481 are stored in the incorporated memory provided in the system control section 480.

The destination recognizing section 482 acquires destination information concerning the destination set and inputted, for instance, in response to an input operation in the operating section 440 to recognize a position of the destination. The destination information set and inputted as described above includes various types of information each for identifying a place such as geographical coordinates including the latitude and the longitude, the address, and the telephone number. The destination information recognized by the destination recognizing section 482 is stored in the incorporated memory.

The set processing section 483 recognizes a matter set and inputted, for instance, in response to an input operation in the operating section 440 and makes the terminal device 400 executes a necessary operation according to the set matter. For instance, the set processing section 483 controls the terminal communication section 410 to send and receive information or the voice guidance section 460 or the display section 450 to execute necessary operations. Further, when matter set as described above is communication condition information as acquisition condition information concerning the conditions for executing a communicating operation for acquiring information, the set processing section 483 stores the information in the internal memory or the storing section 470 in association with the information acquired under the condition.

Based on the previously acquired travel route information, in response to the running state of the vehicle, the guidance reporting section 484 reports guidance for movement of a vehicle stored in incorporated memory or the like, namely guidance for assisting travel of the vehicle, by displaying images with the display section 450 or by generating voices with the voice guidance section 460. For instance, a prespecified arrow mark or a sign are displayed on a screen of the display section 450, or voice guidance such as “Turn right to #### at the cross ****700 meters ahead”, “Your are off from the travel route”, or “Traffic jam ahead” is provided with voices from the voice guidance section 460.

The communication possibility determining section 485 recognizes the communication condition information included in the information stored in the incorporated memory or in the storing section 470, and determines again whether or not the communicating operation for acquiring the information can be executed by operating the terminal communication section 410 under the conditions specified in the information. The communication possibility determining section 485 acquires time information concerning a current data and time with an incorporated clock (not shown) provided in the system control section 480. When it is determined that the communicating operation can be executed, the communication possibility determining section 485 outputs a prespecified signal to the set processing section 483 so that the set processing section 483 controls the terminal communication section 410 to execute the communicating operation.

The terminal communication section 410, set processing section 483, and communication possibility determining section 485 form the information acquisition control unit according to the present invention. With the information acquisition control unit and the information storing section 320 of the main server 300, the information acquisition control system according to the present invention is configured.

(Operations of the Navigation System)

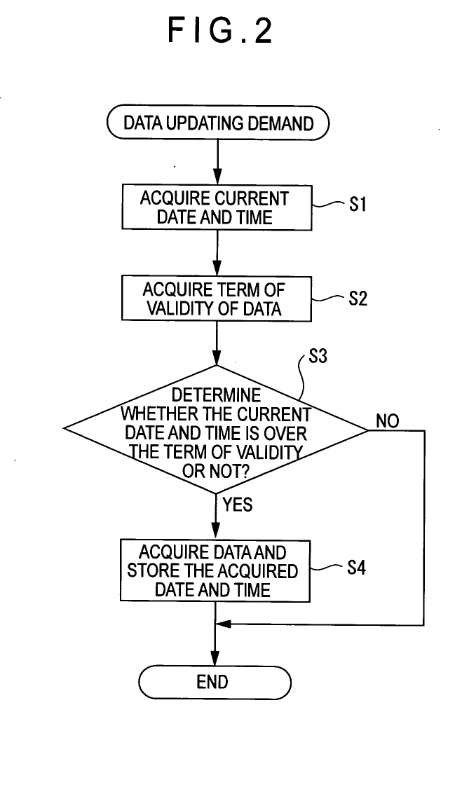

The operations of the navigation system 100 are described below with reference to the related drawings. FIG. 2 is a flow chart showing operations for guidance by the navigation system.

At first, a driver or other person on a vehicle as a user of the navigation system turns ON a power supply for the terminal device 400 to supply power thereto. When the power is supplied, the system control section 480 controls the display section 450 to display a main menu for prompting the user to set contents of the operations of the terminal device 400. Then the user sets and inputs data for execution of the processing for searching a route on which the vehicle travels in response to an input operation in the operating section 440. Namely in this route search operation, the user sets and inputs data required for acquiring information concerning a travel route desired by the user.

When the data set and inputted for searching a travel route is recognized, the system control section 480 makes the current position recognizing section 481 execute the processing for recognizing a current position and also makes the destination recognizing section 482 execute the processing for recognizing the destination.

Namely the system control section 480 acquires, through the current position recognizing section 481, current position information by computing a current position of the vehicle based on the vehicle's speed data and the azimuth data outputted from the speed sensor 431 and the azimuth sensor 432 of the detecting section 430 as well as the GPS data concerning the current position outputted from the GPS receiving section 420. The acquired current position information is stored in the incorporated memory.

The system control section 480 controls the display section 450 to display a message for prompting the user to set and inputs data for the destination in response to an input operation in the operating section 440. Upon the user inputs the data for the destination in response to the input operation in the operating section 440 and according to the instruction displayed on the screen, the destination recognizing section 482 acquires the destination information concerning the destination set and inputted as described above. The acquired destination information is stored in the incorporated memory.

In the case that the map information is demanded by the user when inputting data for setting a destination in the operating section 440, the system control section 480 determines with the communication possibility determining section 485 whether or not the demanded map information is stored in the storing section 470. When it is determined that the map information is not stored in the information possibility determining section 485, since the communication condition information included in the map information can not be recognized, the execution of communication is determined possible. Then the set processing section 483 controls the terminal communication section 410 to execute the communicating operation for acquiring the map information from the main server device 300 via the network 200 to acquire the map information.

The map information acquired as described above is subjected to the processing by the set processing section 483 to recognize contents of the acquired map information, and is stored in a region of the storing section 470 for storing map information therein. Further the set processing section 483 executes the processing for having the map information displayed on the display section 450 for prompting the user to set a destination on the map information. Then, as described above, when the user sets and inputs data for setting a destination by performing an input operation in the operating section 440, the destination information concerning the destination set and inputted is acquired by the destination recognizing section 482 and stored in the incorporated memory.

When it is determined by the communication possibility determining section 485 that the map information is stored in the storing section 470, the communication possibility determining section 485 acquires time information concerning the current data and time with an incorporated clock (not shown) provided in the system control section 480 (step S1). Further the communication possibility determining section 485 recognizes the information concerning the term of validity of the map information which is communication condition information included in the map information (step S2). Then the communication possibility determining section 485 determines whether or not the communicating operation to execute communications can be executed. Namely the communication possibility determining section 485 determines whether or not the current data and time acquired in step S1 is over the term of validity of the map information acquired in step S2 (step S3).

When it is determined by the communication possibility determining section 485 that the current data and time is not over the term of validity of the map information, the communication possibility determining section 485 outputs a signal for inhibiting the communicating operation to the set processing section 483 and terminates the processing of determining whether or not the communicating operation can be executed. It is to be noted that the configuration is allowable in which the processing of determining whether the communicating operation can be executed or not is not terminated with the system control returned to step S1 and waiting for pass-over of the term of validity. Then the set processing section 483 has the map information stored in the storing section 470 displayed on the display section 450 for prompting the user to set a destination on the map information. Then, as described above, when a destination is set in response to an input operation in the operating section 440, the set processing section 483 generates the destination information and stores the destination information in the incorporated memory.

When it is determined by the communication possibility determining section 485 that the current date and time is over the term of validity of the map information, the communication possibility determining section 485 determines that the communicating operation is possible, and outputs a signal for executing the communicating operation to the set processing section 483. Then the set processing section 483 controls the terminal communication section 410 and executed the processing for acquiring updated new map information (step S4). Incidentally, the set processing section 483 has the newly acquired map information associated with the time information for the current date and time stored in the storing section 470, and also executes the processing for deleting the old map information previously stored therein. Then the set processing section 483 has the acquired new map information displayed, generates the destination information in response to an operating for setting a destination, and has the destination information stored.

The system control section 480 controls the display section 450 to display a message for prompting a user to carry out an input operation for inputting a set matter which is a condition for searching a route. When the user sets and inputs a set matter by carrying out an input operation in the operating section 440 according to an instruction displayed on the screen, the set processing section 483 acquires the set matter information concerning the set matter set and inputted as described above. The acquired set condition information is stored in the incorporated memory.

Then the system control section 480 controls the terminal communication section 410 to execute the processing for transmitting the current position information, destination information and set matter information stored in the incorporated memory to the main server 300. Then the main server 300 executes, through the travel route setting section 330, the route search processing for setting a travel route which is an operation for searching a travel route for the vehicle from the current position to the destination based on the acquired current position, destination information, and set matter information. Further the travel route setting section 330 selects some travel routes from the plurality of detected travel routes based on the set matter information, and acquires the travel route information concerning a travel route satisfying the conditions desired by the user.

Based on the information such as an ID number identifying the terminal device 400 that is transmitted together with the set matter information, the main server 300 controls the server communication section 310 to send the travel route information, which is acquired in the route searching step, to the specified terminal device 400. Then the system control section 480 of the terminal device 400, which have acquired the travel route information, has the travel route information stored in the incorporated memory, storing section 470 or the like, and also controls the display section 450 to display the travel route information in the manner that the travel route information is superimposed on the map information.

Then the system control section 480 recognizes the moving state of the vehicle based on the data outputted from the speed sensor 431, azimuth sensor 432, and acceleration sensor 433 of the detecting section 430 as well as on the GPS data outputted from the GPS receiving section 420. Further the system control section 480 reports, with the guidance reporting section 484, the guidance information concerning movement of the vehicle based on the recognized movement state and the travel route information acquired from the main server device 300 to guide the vehicle for smooth movement.

During movement of the vehicle, the guidance reporting section 484 acquires, for instance, traffic information concerning traffic jamming, a traffic accident, traffic controls, or weather information. Further, the guidance reporting section 484 reports, when it is determined based on the acquired traffic information or weather information that the movement state of the vehicle may be affected or changed, a guidance including the information suggesting the possibility or contents of the influence or the change.

Namely, the guidance reporting section 484 outputs a signal demanding the traffic information or weather information along the acquired travel route up to the destination to the set processing section 483. Then the set processing section 483 determines whether or not the demanding information is stored in the incorporated memory or in the storing section 470.

When it is determined that the demanded information is not stored, the set processing section 483 controls the terminal communication section 410 to execute the processing for acquiring the demanded information through the network.

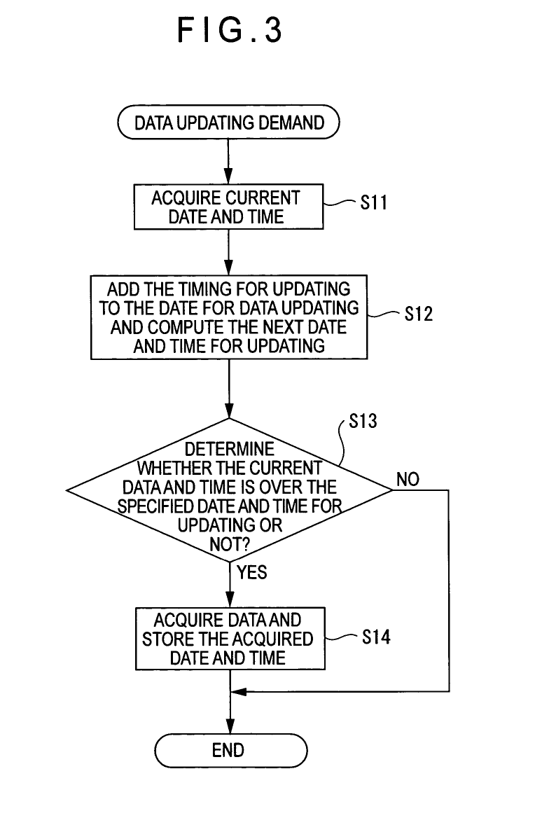

When it is determined that the demanded information is stored, as described above, whether the stored information is to be used or new information is to be acquired is determined based on the communication condition information included in the information. More specifically, in the case of information having the contents relatively frequently updated such as traffic information or weather information, as shown in FIG. 3, an operation for periodically acquiring information is carried out based on the information concerning the date and time of updating included in the information, and time information concerning a date and time of announcement and preparation of the information such as weather information.

Namely, as shown in FIG. 3, at first the time information concerning the current data and time is acquired by the communication possibility determining section 485 (step S11). Further the communication possibility determining section 485 recognizes the time information concerning the data and time of updating or the like which is communication condition information included in the stored information demanded. Then the communication possibility determining section 485 computes a date and time when information is acquired and updated next based on the updating timing previously set, namely on the time information concerning a time interval for updating set and stored in the incorporated memory (step S12). Then the communication possibility determining section 485 determines whether or not the communicating operation for executing communications can be executed. Namely the communication possibility determining section 485 determines whether or not the current date and time acquired in step S11 is over the date and time for updating acquired in step S12 (step S13).

When it is determined by the communication possibility determining section 485 that the current date and time is not over the specified date and time for updating, the communication possibility determining section 485 determines that the new information has not been updated yet, outputs a signal for inhibiting the communicating operation to the set processing section 483, and terminates the processing for determining the possibility of the communicating operation. Then the set processing section 483 executes the processing for reporting by having the information stored in the storing section 470 displayed on the display section 450 or acoustically outputting the information with voices from the voice guidance section 460. It is to be noted, as described above, that the configuration is allowable in which the processing for determining the possibility of the communicating operation is not terminated and a loop processing is carried out for automatically acquiring information by recognizing that the current date and time has passed the specified date and time for updating.

When it is determined in step S13 by the communication possibility determining section 485 that the current date and time has passed the specified date and time for updating the map information, the communication possibility determining section 485 outputs a signal indicating that the communicating operation can be executed, namely a signal for executing the communicating operation is outputted to the set processing section 483. Then the set processing section 483 controls the terminal communication section 410 as described above to execute the processing for acquiring the updated new information (step S14). Incidentally, the set processing section 483 associates the new information with the time information for the current date and time as a date and time for updating as described above, stores the information in the storing section 470 or in the incorporated memory, and also deletes the old map information having been stored therein. Then the set processing section 483 executes the processing for reporting the acquired new information.

On the other hand, for instance, during movement of a vehicle, when the system control section 480 recognizes an input operation by a user for demanding information such as store information concerning sight-seeing spots, leisure facilities, restaurants, gas stations, convenience stores or event information concerning festivals or the like, the system control section 480 provides controls for having information concerning an target store displayed. Namely, in response to the input operation for having information such as store information displayed, the system control section 480 executes the processing for reading out the demanded information such as the store information or event information stored in the incorporated memory, or the storing section 470.

When reading out the demanded information, like in the case of the map information described above, if there is no demanded information, the processing is performed for acquiring the demanded information by the terminal communication section 410 via the network from the main server 300 or various types of server devices. If there is the demanded information, as shown in the flow charts shown in FIG. 2 or FIG. 3, based on the communication condition information for the term of validity or a date and time for updating included in the information, controls are provided so that the information is outputted as it is when updating is not required, and new information is acquired when updating is required and the new information is displayed or outputted as voices.

Further while driving a vehicle is traveling along the travel route, when the system control section 480 recognizes a communication demand information as acquisition demand information which is a demand for acquiring and disclosing the map information or the like to check area information, weather information, or map information of the destination, the communication possibility determining section 485 determines contents of the demand information. Further the communication possibility determining section 485 compares the determined contents to those of the acquired information such as routes, stores, and weather to determine whether or not the two pieces of information are identical to each other.

When it is determined that the demand information set and inputted is identical to the information previously acquired, the communicating operation can not be executed although the demand is set and inputted. Namely the communication possibility determining section 485 outputs a signal for inhibiting the communicating operation to the set processing section 483. With this operation, the set processing section 483 provides controls so that the information will not be acquired by the terminal communication section 410.

When it is determined that the demand information set and inputted is not identical to the information previously acquired, namely, for instance, when map information for an area is different from that shown by the map information previously acquired, the communication possibility determining section 485 determines that the communication operation can be executed, and outputs a signal for acquiring information according to the demand to the set processing section 483. With this operation, the set processing section 483 controls the terminal communication section 410 to acquire the information satisfying the demand.

As described above, in the embodiment described above, whether or not the communicating operation can be executed is determined by the communication possibility determining section 485 based on the communication condition information concerning that for the term of validity or the like included and updated at a prespecified time interval in the side distributing the information such as map information, and when it is determined that the communicating operation can be executed, the set processing section 483 controls the terminal communication section 410 to execute the communicating operation for acquiring the updated new information. Because of the configuration as described above, it is possible to prevent disadvantage such as increased processing load or high communication cost by, for instance, having the communicating operation for acquiring information executed at a prespecified time interval, and further it is possible to easily acquire the latest information required for driving the vehicle and to improve the efficiency in acquiring information.

In the case of the information updated with a relatively shorter time interval such as traffic information or weather information, the information is associated with the date and time when the information is acquired as the communication condition information, and the communication possibility determining section 485 determines whether or not the communicating operation can be executed based on this communication condition information such as the date and time. When it is determined that the communicating operation can be executed, the set processing section 483 controls the terminal communication section 410 to execute the communicating operation for acquiring the updated new information. Because of this feature, it is possible to prevent disadvantage such as increased processing load or high communication caused by keeping the communication continuously online to acquire information, and in addition it is possible to easily acquire the latest information required for driving a vehicle, which improves the efficiency in information acquisition.

The system control section 480 recognizes the communication demand information set and inputted in the operating section 440, and the communication possibility determining section 485 determines whether contents of the demanded information is identical to those of the information previously acquired, and when it is determined that the two pieces of information are not identical to each other, the communication possibility determining section 485 determines that the communicating operation can be executed, and the set processing section 483 executes the processing for acquiring the information. Because of this configuration, it is possible to avoid executing the processing for acquiring information which is identical to that previously acquired, which prevents increase in the processing load and communication cost and enables efficient acquisition of information.

Even if a demand for acquiring information is recognized in response to an input operation in the operating section 440, when it is determined by the communication possibility determining section 485 that the communicating operation can not be executed, execution of the communicating operation is inhibited. Because of the feature, times of communicating operations for acquiring information can be minimized, which further improves the efficiency in information acquisition.

Further by setting the communication condition information of date and times for updating or the like according to a cyclic timing for updating, whether the communicating operation for acquiring the updated information can be executed or not is determined based on this communication condition information. Because of this feature, execution of unnecessary operations for acquiring information can be prevented, and the processing for efficiently acquiring information can easily be realized.

The time information concerning the term of validity or date and time for updating is used as the communication condition information for determination whether or not the communicating operation can be executed, and the communication possibility determining section 485 compares the time information to the current date and time indicating a current point of time. When it is determined that the current date and time is over the timing specified in the communication condition information, the communication possibility determining section 485 determines that the communicating operation can be executed, and executes the communicating operation. Because of this feature, execution of unnecessary operation for acquiring information can be prevented, which makes it possible to easily and efficiently acquire information.

The operation for acquiring information is performed as a communicating operation. With this configuration, especially unnecessary communications can be prevented and therefore the communication cost is reduced, and information can be acquired efficiently.

Further, as described above, by applying the system to a navigation system for acquiring information required for driving a movable body such as a vehicle, it is required only to acquire necessary information for reporting a guidance in response to the driving situation of the movable body according to the necessity, so that it is not necessary to previously store map information or the like requiring a large storage space, nor to use a drive for reading out the map information from a recording medium such as an optical disk in which the map information is previously stored, which enables size reduction and makes it easier to acquire the updated latest map information and also to report the guidance with the terminal device 400 based on the latest map information in the stable condition, and therefore a smooth and accurate guidance for a movable body can be acquired, and its application range can easily be expanded.

Further the main server device 300 is provided with the travel route searching section for searching a travel route, and a result of searching can be acquired by operating the main server device 300, so that the configuration can be simplified.

Further old information stored in the storing section 470 or the incorporated memory is replaced with new information acquired newly, so that the old information is deleted and the limited storage space can efficiently be used, which enables efficient storage of acquired information.

Further the processing can be varied based on the term of validity or the date and time for updating, as shown in the flow charts of FIG. 2 and FIG. 3, according to characteristics and types of information need to be updated about, for instance, once a year such as map information, information frequently updated such as traffic information or weather information; information irregularly updated depending on the needs and convenience of the distributor such as store information or area information; travel route information required to acquire each time the travel route is switched to a new one; and information having the similar contents, yet to be treated as different information such as map information for different areas. Because of this feature, only the communicating operation required for acquiring necessary information is executed, which enables more efficient acquisition of accurate information.

(Variants of the Embodiments)

The present invention is not limited to the embodiments described above, and includes the variants as those described below achievable in a range where the objects of the present invention are attained.

In the descriptions of the embodiments above, it is assumed that a movable body is a vehicle, but the present invention can be applied to any types of movable bodies such as airplanes and vessels. Further the present invention can be applied in the configuration in which the device for acquiring information is directly carried by a user, or in the configuration in which the system is configured with a mobile telephone or a PHS (Personal Handyphone System) as the terminal device and a base station for the mobile telephone or the PSH as the main server device and information is acquired with the mobile telephone or PHS from the base station.

Acquisition of information was described above in the navigation system 100 capable of providing guidance in response to the state of a vehicle's movement, but the present invention is not limited to the navigation system 100, and can be applied to the configuration in which various types of information are acquired with, for instance, a personal computer. Further a method of acquiring information is not limited to communication, and also in a case where information is acquired, namely read out from various types of drives or from a storing section with a personal computer, by determining whether the information can be read out or not, and allowing the information acquisition only when it is determined that the information can be read out, the work load in the processing for acquiring information can be reduced with the information acquired efficiently.

Further the configuration is allowable in which the communication possibility determining section 485 always monitors a current date and time and determines, based on the communication condition information included in the information stored in the incorporated memory or in the storing section 470, whether or not the current date and time is over the time specified in the communication condition information; when it is determined that the current date and time is over the time specified in the information, the set processing section 483 automatically acquires new information and updates the information. With the configuration, information successively accumulated is automatically updated, so that accurate information processing or guidance can smoothly be executed.

In the embodiments described above, a date and time for updating is calculated according to a timing previously set, and whether or not the communicating operation can be carried out is determined according to the prespecified date and time for updating, but the configuration is allowable in which, for instance, the timing for information acquisition is manually set by a user according to the user's convenience, and information is acquired once within a prespecified cycle according to the set timing.

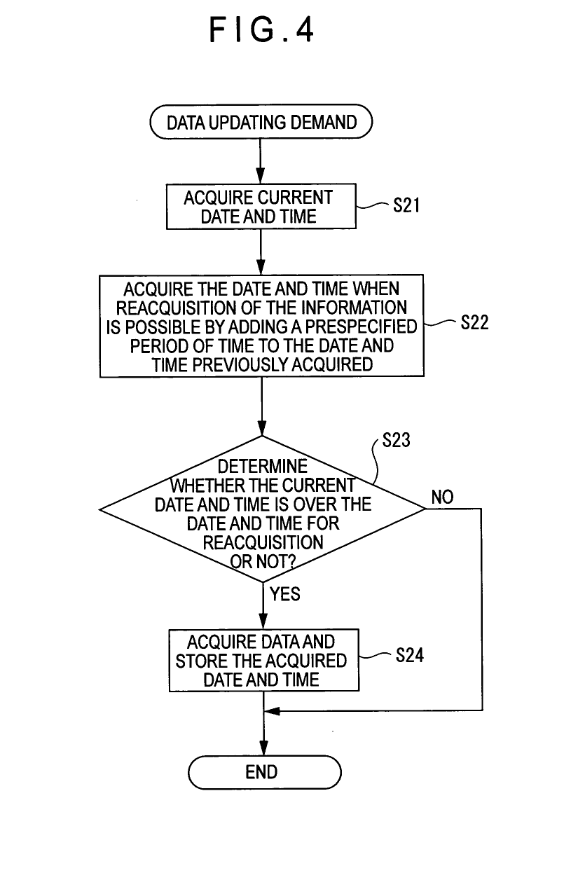

Further in the embodiments described above, information including communication condition information concerning the term of validity or the like is acquired, and the acquired information is associated with the communication condition information such as a scheduled date and time for updating, but also the configuration is allowable in which the communication condition information is not included in information, nor associated, and a user directly determines whether the operation for acquiring information can be carried out or not, as shown in FIG. 4.

It should be noted that the acquired information is one previously specified. In addition, the timing for acquiring the information is previously specified. In the embodiment shown in FIG. 4, information is acquired at a prespecified time interval. In the configuration as shown in the flow chart of FIG. 4, information concerning a current date and time is acquired (step S21). When the information is acquired, a prespecified period of time is added to the current date and time, at which the information is acquired (step S22), and the calculated date and time is separately stored in the incorporated memory. Then the communication possibility determining section 485 determines whether or not the current time is over the calculated date and time for reacquisition of information (step S23), and when it determines that the current date and time is over the calculated date and time for reacquisition of information, the communication possibility determining section 485 determines that the communicating operation can be executed, and executes the processing for reacquiring the information (step S24). With the configuration as shown in FIG. 4, no information need to be associated, and the load for processing can be reduced.

Further in the embodiments described above, the current position information recognized by the current position recognizing section 481 is acquired based on the output data from the various sensors 431 to 433 as well as on the GPS data outputted from the GPS receiving section 420, but any method may be employed for recognizing a current position of a movable body.

In the embodiments described above, the configuration is described in which information concerning several travel routes selected based on the current position information, destination information, and set matter information is sent, but also the configuration is allowable in which travel routes are set, namely the route search is performed based only on the current position information and the destination information; all of the travel routes acquired are sent to the terminal device 400; and a required route is selected in the terminal device 400 in response to data set and inputted in the operatng section 440. With the configuration in which one or more travel routes are sent to the terminal device 400, the load for communication can be reduced, and also complicated operations for selecting a required travel route from a plurality of travel routes can be reduced, whereby the convenience can substantially be reduced.

Further in the embodiments described above, the set processing section 483 and communication possibility determining section 485 are provided as programs for the system control section 480, but also the configuration is allowable in which the components are provided as hardware like, for instance, a circuit board or an IC (Integrated Circuit) chip. Further the components may be provided as programs which can be read from the main server device 300 or can be stored in a recording medium so that the program can again be read out therefrom for running, and thus by providing the components as programs and storing the programs in a recording medium, the system can easily be handled and its application area can be enlarged. What is described above is also applicable to the system control section 480 provided as the computing section according to the present invention. Namely the computing section according to the present invention includes, for instance, one unit of personal computer, a plurality of personal computers combined into a network state, chips such as microcomputer chips, or a circuit board on which a plurality of electric components are mounted.

In the embodiment described above, the terminal communication section 410 is provided, but also the configuration is allowable in which the terminal device 400 and terminal communication section 410 are provided as discrete components, and information is sent or received using, for instance, a mobile telephone or a PHS as the terminal communication device 410 in the state where the terminal communication section 410 is connected to the terminal device 400.

Other components, specific structures, and procedure for carrying out the present invention may be modified and changed according to the necessity in a range where the objects of the present invention can be achieved.

What is claimed is:

1. An information acquisition control unit comprising:
an information acquiring section for acquiring information;
an information processing section for associating the information acquired by the information acquiring section with acquisition condition information concerning the conditions for making the information acquiring section execute an information acquiring operation to acquire information;
an acquisition possibility determining section for determining, based on the acquisition condition information, whether or not the acquiring operation can be executed; and
a control section for controlling the information acquiring section, when it is determined by the acquisition possibility determining section that the acquiring operation can be executed, to execute the acquiring operation.

2. An information acquisition control unit comprising:
an information acquiring section for acquiring information including acquisition condition information concerning the conditions for executing an acquiring operation to acquire information;
an acquisition possibility determining section for determining, based on the acquisition condition information of the acquired information, whether or not the acquiring operation can be executed; and
a control section for controlling the information acquiring section, when it is determined by the acquisition possibility determining section that the acquiring operation can be executed, to execute the acquiring operation.

3. The information acquisition control unit according to claim 1 further comprising:
an input section for setting and inputting an acquisition demand information for demanding execution of the acquiring operation in response to an input operation, wherein said control section provides controls for inhibiting the execution of the acquiring operation, when it is determined by the control section that the acquiring operation cannot be executed by the acquisition possibility determining section, even if the control section recognizes an input for setting the acquisition demand information in the input section.

4. The information acquisition control unit according to claim 2 further comprising:
an input section for setting and inputting an acquisition demand information for demanding execution of the acquiring operation in response to an input operation, wherein said control section provides controls for inhibiting the execution of the acquiring operation, when it is determined by the control section that the acquiring operation cannot be executed by the acquisition possibility determining section, even if the control section recognizes an input for setting the acquisition demand information in the input section.

5. An information acquisition control unit comprising:
an information acquiring section for acquiring information;
an input section for setting and inputting an acquisition demand information concerning a demand for an acquiring operation to acquire the information by the information acquisition section in response to an input operation;
an acquisition possibility determining section for determining whether or not the information demanded from the acquisition demand information and the information acquired by the information acquiring section are identical to each other, and for determining, when the two pieces of information are not identical to each other, that the acquiring operation can be executed; and
a control section for controlling the information acquiring section, when it is determined by the acquisition possibility determining section that the acquiring operation can be executed, to execute the acquiring operation.

6. The information acquisition control unit according to claim 1, wherein said acquisition condition information relates to the conditions for executing the acquiring operation at a timing when the information not identical to the information previously acquired can be acquired.

7. The information acquisition control unit according to claim 2, wherein said acquisition condition information relates to the conditions for executing the acquiring operation at a timing when the information not identical to the information previously acquired can be acquired.

8. The information acquisition control unit according to claim 6, wherein the acquisition condition information is time information concerning time; and said acquisition possibility determining section determines that an acquiring operation can be executed when it recognizes, by comparing the time information concerning the current point of time to said acquisition condition information, that the current point of time has reached the time indicated by the acquisition condition information.

9. The information acquisition control unit according to claim 7, wherein the acquisition condition information is time information concerning time; and said acquisition possibility determining section determines that an acquiring operation can be executed when it recognizes, by comparing the time information concerning the current point of time to said acquisition condition information, that the current point of time has reached the time indicated by the acquisition condition information.

10. The information acquisition control unit according to claim 5 further comprising:
an input section for setting and inputting an acquisition demand information to demand an acquiring operation to make the information acquisition section acquire information with a specified content in response to an input operation, wherein the acquisition condition information is the content information concerning a content of said information; and the acquisition possibility determining section determines that the acquiring operation can be executed when it is determined by comparing contents of the acquisition demand information set and inputted in the input section to those of said acquisition condition information that the two pieces of information are not identical to each other.

11. The information acquisition control unit according to claim 1, wherein the information acquiring section acquires information through communications.

12. The information acquisition control unit according to claim 2, wherein the information acquiring section acquires information through communications.

13. The information acquisition control unit according to claim 5, wherein the information acquiring section acquires information through communications.

14. The information acquisition control unit according to claim 1 further comprising:
a guidance reporting section for reporting a guidance in response to the moving state of a movable body, wherein said information is information concerning movement of the movable body.

15. The information acquisition control unit according to claim 2 further comprising:
a guidance reporting section for reporting a guidance in response to the moving state of a movable body, wherein said information is information concerning movement of the movable body.

16. The information acquisition control unit according to claim 5 further comprising:
a guidance reporting section for reporting a guidance in response to the moving state of a movable body, wherein said information is information concerning movement of the movable body.

17. An information acquisition control system comprising:
an information storing section for distributably storing therein different types of updatable information; and
the information acquisition control unit according to claim 1 connected thereto so that the information stored in this information storing section can be acquired by said information acquiring section.

18. An information acquisition control system comprising:
an information storing section for distributably storing therein different types of updatable information; and
the information acquisition control unit according to claim 2 connected thereto so that the information stored in this information storing section can be acquired by said information acquiring section.

19. An information acquisition control system comprising:
an information storing section for distributably storing therein different types of updatable information; and
the information acquisition control unit according to claim 5 connected thereto so that the information stored in this information storing section can be acquired by said information acquiring section.

20. A method of controlling information acquisition for controlling information acquisition with a computing section, wherein the computing section operation comprising the steps of:
associating acquired information with acquisition condition information concerning the conditions for executing an acquiring operation to acquire the information;
determining, based on the acquisition condition information associated with this information, whether or not the acquiring operation can be executed; and
executing the acquiring operation to separately acquire the information when it is determined that this acquiring operation can be executed.

21. A method of controlling information acquisition for controlling information acquisition with a computing section, comprising the steps of:
determining, based on the acquisition condition information in the information acquired in advance and including acquisition condition information concerning the conditions for executing an acquiring operation to acquire the information; and
executing the acquiring operation to separately acquire the information when it is determined that this acquiring operation can be executed.

22. A method of controlling information acquisition for controlling information acquisition with a computing section, comprising the steps of:
recognizing an input for setting an acquisition demand information concerning a demand for an acquiring operation to acquire information in response to the input operation; and
executing the acquiring operation to separately acquire information when it is determined by means of comparison that the information demanded from the acquisition demand information and the acquired information are not identical to each other.

23. An information acquisition control program for making a computing section execute the information acquisition control method according to claims 20.

24. An information acquisition control program for making a computing section execute the information acquisition control method according to claims 21.

25. An information acquisition control program for making a computing section execute the information acquisition control method according to claims 22.

26. A recording medium with an information acquisition control program recorded therein, wherein the information acquisition control program according to claim 23 is recorded therein so that the program can be read by a computing section.

27. A recording medium with an information acquisition control program recorded therein, wherein the information acquisition control program according to claim 24 is recorded so that the program can be read by a computing section.

28. A recording medium with an information acquisition control program recorded therein, wherein the information acquisition control program according to claim 25 is recorded so that the program can be read by a computing section.

29. A navigation system comprising:
an information acquisition control system according to claim 17 with the information storing section storing therein information concerning movement of a movable body as information;
a movable body information acquiring section provided in the information acquisition control unit of this information acquisition system for acquiring information concerning the state of movement of a movable body; and
a guidance reporting section provided in the information acquisition control unit for reporting at least either one of the acquired information and a guidance corresponding to the moving state of a movable body based on this acquired information.

30. A navigation system comprising:
an information acquisition control system according to claim 18 with the i information storing section storing therein information concerning movement of a movable body as information;
a movable body information acquiring section provided in the information acquisition control unit of this information acquisition system for acquiring information concerning the state of movement of a movable body; and
a guidance reporting section provided in the information acquisition control unit for reporting at least either one of the acquired information and a guidance corresponding to the moving state of a movable body based on this acquired information.

31. A navigation system comprising:
an information acquisition control system according to claim 19 with the information storing section storing therein information concerning movement of a movable body as information;
a movable body information acquiring section provided in the information acquisition control unit of this information acquisition system for acquiring information concerning the state of movement of a movable body; and
a guidance reporting section provided in the information acquisition control unit for reporting at least either one of the acquired information and a guidance corresponding to the moving state of a movable body based on this acquired information.
